(19) United States
(12) Patent Application Publication
(10) Pub. No.: US 2026/0146971 A1
(43) Pub. Date: May 28, 2026

(54) SYSTEM FOR CHARACTERIZING CHIRAL MOLECULES WITH PULSE RECYCLING

(71) Applicants: CENTRE NATIONAL DE LA RECHERCHE SCIENTIFIQUE, PARIS (FR); COMMISSARIAT A L'ENERGIE ATOMIQUE ET AUX ENERGIES ALTERNATIVES, PARIS (FR); UNIVERSITE DE BORDEAUX, BORDEAUX (FR)

(72) Inventors: Antoine COMBY, BORDEAUX (FR); Dominique DESCAMPS, TALENCE cedex (FR); Yann MAIRESSE, BORDEAUX (FR); Stéphane PETIT, BELIN-BELIET (FR)

(73) Assignees: CENTRE NATIONAL DE LA RECHERCHE SCIENTIFIQUE, PARIS (FR); COMMISSARIAT A L'ENERGIE ATOMIQUE ET AUX ENERGIES ALTERNATIVES, PARIS (FR); UNIVERSITE DE BORDEAUX, BORDEAUX (FR)

(21) Appl. No.: 18/872,938

(22) PCT Filed: Jun. 6, 2023
(86) PCT No.: PCT/EP2023/065064

§ 371 Date: Dec. 5, 2025

(30) Foreign Application Priority Data
Jun. 10, 2022 (FR) FR2205631

(51) Int. Cl. G01N 27/64

(52) U.S. Cl. CPC G01N 27/64

(57) ABSTRACT

A system for characterizing chiral molecules including an interaction zone arranged to receive a sample of chiral molecules; a laser source arranged to emit pulsed laser radiation, the laser radiation being suitable for interacting with the molecules in the interaction zone; a polarization modulator arranged to elliptically polarize the laser radiation; an optical cavity configured to redirect the pulsed laser radiation into the interaction zone several times; a detector arranged to measure a chiroptical signal produced by the interaction between the molecules and the laser radiation; and a determiner arranged and/or programmed to determine at least the chirality of the molecules from the detected chiroptical signal.

### TECHNICAL FIELD

The present invention relates to a system for characterizing chiral molecules.

The field of the invention is the field of chemical analysis of mixtures of chiral molecules.

### BACKGROUND

The analysis of chemical mixtures is an essential tool in numerous industrial processes, from R&D to quality control. These molecules exist in at least two forms called enantiomers which are not superimposable on their mirror image, and one of the forms may be toxic.

Chiral molecules are particularly difficult to analyze. However, these molecules play a crucial role in numerous industrial fields such as pharmacology, food processing, agricultural chemistry, etc., where enantiomeric purity can be of paramount importance. For example, the majority of drugs and pharmaceutical compounds comprise chiral molecules. Since the reaction of an organism to a molecule can depend on its chirality, it is crucial to know the enantiomeric composition of the molecules of these compounds. The enantiomeric excess of a product must be determined to an accuracy of 99.9% before it can be marketed.

A historic technique for analyzing molecular chirality is based on circular dichroism (CD). By measuring the difference in absorption of right-or left-hand circularly polarized radiation, it is possible to obtain information about the chirality of a sample. However, CD is a very weak effect, requiring dense samples (liquids) and therefore large quantities of material. It provides weak signals, requiring long acquisitions to obtain a good signal-to-noise ratio.

To overcome this problem, new types of circular dichroism have been developed. For example, a well-known technique, photoelectron circular dichroism (PECD), involves the ionization of chiral molecules in a gaseous sample by circularly polarized radiation. The angular distribution of electrons ejected by ionization shows strong asymmetry along the axis of light propagation. Thus, more or fewer electrons are emitted forwards or backwards, depending on the helicity of the light (direction of rotation of the circular polarization) or the enantiomericity of the molecule. This technique can use radiation in the extreme ultraviolet (XUV) range for single-photon ionization, or ultraviolet, visible or infrared laser radiation, in which case ionization is multi-photon.

It is also possible to use a variant of PECD, called photoelectron elliptical dichroism (PEELD). In this case, the polarization state is varied continuously by oscillating a natural frequency ω. The angular distribution will thus oscillate at multiples of this frequency ω. The asymmetrical forwards/backwards signal will oscillate at odd multiple frequencies, and the amplitude of these oscillations gives the chiral composition of a measured sample. This synchronous detection gives a much better signal-to-noise ratio.

Typically, the accuracy of chirality measurements depends directly on the signal level detected. The higher the signal, the higher the signal-to-noise ratio.

For this reason, methods based on the use of pulsed lasers benefit greatly from the increased repetition rate of these light sources. The higher the number of pulses delivered, the more accurate the measurement. However, increasing the repetition rate of a laser requires an increase in the average laser power, which leads to significant additional costs. The cost of a laser source is highly dependent on the power delivered.

### SUMMARY

One aim of the present invention is to propose a characterization system that can overcome these problems.

One aim of the present invention is to propose a measurement system that allows the chirality of molecules to be measured accurately and quickly.

It is also an aim of the present invention to propose a measurement system with controlled operating costs.

At least one of these objectives is achieved with a system for characterizing chiral molecules, comprising:
an interaction zone arranged to receive a sample of chiral molecules;
a laser source arranged to emit pulsed laser radiation, the laser radiation being suitable for interacting with the molecules in the interaction zone;
a polarization modulator arranged to elliptically polarize the laser radiation;
an optical cavity configured to redirect the pulsed laser radiation into the interaction zone several times;
detection means arranged to measure a chiroptical signal produced by the interaction between the molecules and the laser radiation; and
determination means arranged and/or programmed to determine at least the chirality of the molecules from the detected chiroptical signal.

The characterization system according to the present invention can be used to determine the chirality of molecules by virtue of the interaction of an elliptically polarized laser beam with these molecules. By recycling the laser pulses, a lower-power laser can be used, while increasing the effective average power and the effective rate. The interactions of the molecules with the different beams add up to produce a signal corresponding to the superposition of several substantially identical signals. By reversing the direction of propagation of the laser beam in the optical cavity, the direction of rotation of the electromagnetic field polarization is also reversed. This double-inversion increases the signal level, thus reducing measurement time. In addition, the accuracy of the measurement is also increased by virtue of the higher average effective power. By virtue of the simple and easy-to-implement optical assembly of the recycling optical cavity, a powerful and fast characterization system can be obtained at moderate cost, without the need to integrate a pulsed laser source with high average power.

An implementation example of the invention is based on the elliptical dichroism of electrons, or photoelectrons, measured continuously. Thus, the evolution of the distribution of electrons emitted forwards and backwards, and therefore its asymmetry, is measured as a function of time and as a function of the polarization state of the electromagnetic radiation. By varying the ellipticity of the radiation polarization continuously and periodically as a function of time, the continuously measured signal is a periodic signal allowing simpler and faster analysis of the sample of molecules.

According to one embodiment, the interaction comprises ionization of the molecules, and the detection means may comprise an electron detector arranged to detect a distribution of electrons produced by the ionization emitted in front of and behind the interaction zone with respect to the axis, z, of laser radiation propagation.

In the context of the present invention, the term “electron distribution” can mean both:
a number of electrons, obtained by simple counting,
a spatial distribution of electrons, or
an angular distribution of electrons,
with the electrons being emitted to the front and rear of the ionization zone, with respect to the axis of propagation of the ionizing radiation.

Thus, in the context of the present invention, the chirality of the molecules in the sample can be determined from the number of forward emitted electrons and the number of backward emitted electrons. As the optical cavity reverses both the direction of propagation of the light and the direction of rotation of its polarization (helicity), the electron asymmetry on the detector has the same sign each time the laser beam passes through the sample, thus increasing the signal.

Advantageously, the optical cavity may be formed by two spherical mirrors.

The mirrors are arranged so that the light beam reflected from the mirrors is always focused at substantially the same point and makes as many round trips as possible.

In particular, it is important that the mirror diameters are large compared to the initial laser beam size.

Alternatively, the optical cavity may be formed by two flat mirrors.

According to one variant, each of the flat mirrors can be combined with a lens.

The choice of optical cavity construction depends in particular on the desired shape of the beam in the cavity (e.g., whether or not it is focused in the cavity).

According to one embodiment, the polarization modulator may be arranged to vary the polarization ellipticity of the laser radiation continuously as a function of time.

According to one example, the polarization modulator may comprise a quarter-wave plate arranged to be rotated about the axis, z, of laser radiation propagation.

Such a modulator is particularly simple to implement, space-saving and cost-effective. Commercially available motorized rotation devices can be used with the quarter-wave plate.

Other types of polarization modulator can also be used, such as electro-optical elements (Pockels cell, etc.).

According to one variant, polarization ellipticity can be modulated by interferometric control of the two polarization components.

According to one example, the electron detector may comprise at least one velocity vector imager.

According to one embodiment, the pulsed laser source may be a pulsed laser source delivering femtosecond pulses.

According to a non-limiting example, the wavelength of the pulsed laser source may be in the ultraviolet to visible range.

According to an advantageous variant, the pulsed laser source may be a high-repetition-rate fiber laser.

Such laser sources are commercially available and are easy to implement with the system according to the invention.

Typically, the wavelength of the electromagnetic radiation source determines the type of molecule ionization, either single-photon ionization or multi-photon ionization.

Pulsed laser sources having wavelengths in the visible, infrared or ultraviolet range produce radiation that can cause multi-photon ionization. On the other hand, far-ultraviolet or extreme light sources can induce single-photon ionization, whether continuous or pulsed.

Typically, the determination means comprise at least one computer, a central processing or computing unit, an analog electronic circuit (preferably dedicated), a digital electronic circuit (preferably dedicated), and/or a microprocessor (preferably dedicated), and/or software means.

The system according to the invention can be used to measure the chirality of molecules in the field of pharmacology, food processing or even pesticides. Indeed, these and other industries need reliable and rapid chiral analysis techniques, particularly in the development phases of new compounds, in order to identify, for example, reaction products and their enantiomeric excesses.

According to a first application example, it can be very useful to monitor in real time the composition of a mixture in which a chemical reaction is taking place. This reaction monitoring can be carried out directly with the system according to the invention, in particular by collecting the vapors emitted by the reservoir in which the reaction takes place.

According to a second application example, it can be very useful to carry out chiral analysis measurements in series, particularly when synthesizing multiple products with very similar structures in research and development, where reliability and speed are very important factors. For example, different functional groups can be substituted for a base molecule to converge on a compound having optimal desired properties. In this specialized field, the intermediate compounds to be measured are often generated in small quantities, a constraint which the system according to the present invention proposes to respect.

According to a third application example, chiral analysis is carried out in quality control and particularly at the end of production. Ideally, the enantiomeric excess and its evolution over time can be quantified by very regular, or even continuous, sampling of very small quantities of the products to be analyzed with real-time analysis.

According to a fourth application example, it is possible to carry out screening tests, where for example a very large number of catalysts or operating conditions (temperatures, pH, etc.) are used to direct a chemical reaction to produce preferentially one enantiomer rather than another.

More generally, the measurement system according to the invention can be used to analyze the enantiomeric purity of a sample of chiral molecules.

### BRIEF DESCRIPTION OF THE FIGURES

Other benefits and features shall become evident upon examining the detailed description of entirely non-limiting examples, and from the appended drawings whereupon:

FIG. 1 is a schematic depiction of a non-limiting exemplary embodiment of a system according to the invention;

FIG. 2 shows examples of focus measurements in the optical cavity of a system according to one embodiment;

FIG. 3 schematically depicts the interaction of laser radiation with a sample in an optical cavity of a system according to the invention;

FIG. 4 shows examples of chiroptical signal measurements with a system according to the invention; and

FIG. 5 presents the results of measurements carried out with a system according to the invention.

### DETAILED DESCRIPTION

It is clearly understood that the embodiments that will be described hereafter are by no means limiting. It is especially possible to imagine variants of the invention that comprise only a selection of the features disclosed hereinafter in isolation from the other features disclosed, if this selection of features is sufficient to confer a technical benefit or to differentiate the invention with respect to the prior state of the art. This selection comprises at least one preferably functional feature which lacks structural detail, or only has a portion of the structural details if that portion only is sufficient to confer a technical benefit or to differentiate the invention with respect to the prior state of the art.

In particular, all of the described variants and embodiments can be combined with each other if there is no technical obstacle to this combination.

In the figures, the same reference may be used for the features that are common to several figures.

[FIG. 1] is a schematic depiction of a non-limiting exemplary embodiment of a measurement system according to the invention.

The system 1, depicted in [FIG. 1], comprises a pulsed laser source 10.

According to one example, this laser source 10 is a frequency-doubled fiber laser source (e.g. 515 nm) by means of non-linear crystals. The pulses emitted are femtosecond pulses, for example of the order of 350 fs at a rate of 100 kHz. The energy per pulse is of the order of 20 μJ for an average power of 2 W. With such a laser source, molecules are ionized using resonance-enhanced multi-photon ionization.

There are various types of femtosecond laser sources for use in the context of the invention, which are well known to the skilled person and will not be detailed herein.

The system 1 further comprises a molecule reservoir 11. The mixture of molecules in the reservoir 11 may be single or multi-species. The mixture may be present in solid, liquid or gaseous form. The reservoir 11 may be, for example, a flask.

A sample of molecules is conveyed, in gaseous form, through a gas pipe 12 towards an interaction or ionization zone 13. To obtain the gaseous form when the mixture in the reservoir 11 is solid or liquid, the reservoir 11 can, for example, be heated.

The ionization zone 13 is typically implemented by a vacuum chamber 18 into which the gas is introduced.

The light beam 14 emitted by the laser 10 is directed towards and focused in the interaction zone 13 using known beam-forming means, such as mirrors and lenses, depicted by reference 15 in [FIG. 1].

The beam-forming means 15 may notably comprise a focusing lens of focal length f. With reference to [FIG. 1], the beam 14 is focused by the lens 15 so that the focal point lies in the interaction zone 13. The light intensity at this first focal point is, for example, of the order of 10¹²-10¹³ W/cm².

The system 1 according to the invention also comprises an optical cavity 19, arranged so that the interaction zone 13 is located inside the cavity 19. In the example depicted in [FIG. 1], the optical cavity 19 comprises two mirrors 20a, 20b arranged inside the vacuum chamber 18. Mirrors 20a and 20b are spherical focusing mirrors with focal lengths f₁ and f₂ respectively.

The light beam 14, after being focused in the interaction zone 13 by the focusing lens 15, diverges and arrives at the second mirror 20b. The second mirror is positioned at a distance of 2f₂ from the focal plane of the lens 15. The beam 14 is thus reflected by the second mirror 20b and refocused in a focal plane corresponding to the first focal point of the lens 15. After being focused in the second focal point of the second mirror 20b, the beam diverges and arrives at the first mirror 20a positioned at a distance of 2f₁ from the focal plane. The beam 14 is thus reflected by the first mirror 20a and even refocused at the same point as the first and second focal points. The mirrors 20a, 20b are aligned so that the light beam 14 passes back and forth through the cavity 19 a large number of times. To achieve this, the initial diameter of the beam must be small with respect to the diameters of the mirrors 20a, 20b and of the lens 15.

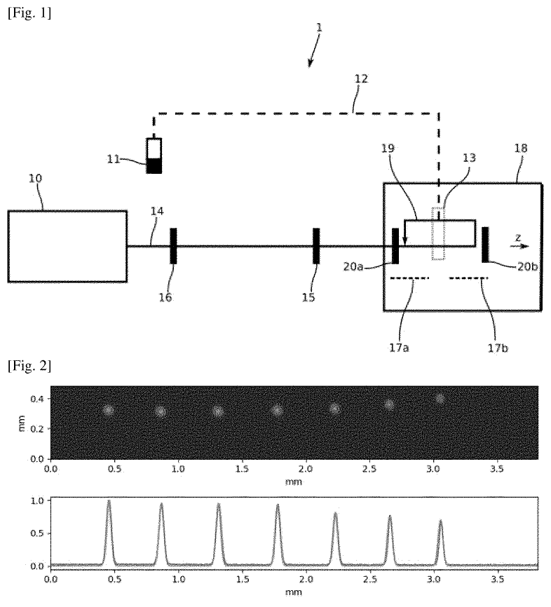

According to one example, with a frequency-doubled laser source (515 nm, 100 kHz, 350 fs) as disclosed hereinbefore, a first mirror 20a with a focal length of 175/2 mm and a second mirror 20b with a focal length of 150/2 mm, both mirrors having a diameter of 25.4 mm, it is possible to obtain about ten reflections per mirror, corresponding to about twenty focal points, before the beam 14 leaves the cavity 19.

[FIG. 2] (a) shows measurements of focal points in the optical cavity 19. To do this, a sampling plate is placed in the middle of the optical cavity 19 to extract part of the beam 14. The light intensities in seven focal points are thus imaged. [FIG. 2] (b) shows the horizontal profiles 40 of the light intensities of [FIG. 2] (a), together with Gaussian curves 41 of equal width. It can be seen that the size of the individual focal points varies very little after multiple round trips of the beam. This means that the beam 14 remains truly focused after these round trips.

The system 1 according to the invention further comprises a polarization modulator 16. Preferably, the polarization modulator 16 is arranged to elliptically polarize the laser radiation 14 and to vary the ellipticity of the polarization continuously as a function of time. Herein, the polarization modulator 16 consists of a quarter-wave plate rotating at 45°/s.

The quarter-wave plate can be rotated by any means known to the skilled person, in particular by means of a motorized plate support.

When the laser radiation interacts with molecules present in the ionization zone, the molecules are ionized, ejecting electrons. Preferably, at least one molecule is ionized by a laser pulse. The electrons are emitted in different directions. Due to the chirality of molecules, the angular and/or spatial distribution of emitted electrons is asymmetric, meaning that more electrons are emitted forwards than backwards, or more electrons are emitted backwards than forwards.

Still with reference to [FIG. 1], the system 1 according to the invention further comprises electron detection means arranged to detect electrons, or photoelectrons, produced by ionization of the molecules and emitted in front of and behind the ionization zone 13 with respect to the z axis of light propagation. In the exemplary embodiment depicted, these detection means are symbolized by plates 17a, 17b positioned in front of and behind the ionization zone 13.

Electron detection means include, for example, a velocity map imaging (VMI) spectrometer. Such a VMI spectrometer images and converts the electronic angular and/or spatial distribution into an optical signal that can be measured by a camera.

Other electron detectors, for example, directly measure the number of electrons emitted forwards and backwards by guiding them over two detectors by virtue of a magnetic field.

When a VMI spectrometer is implemented, the spatial distribution of electrons S(x, z, ε), which depends on the position (x, z) on the detector and the ellipticity of the laser beam polarization ε, is measured. When circular or elliptical polarization is used, electrons are observed moving preferentially backwards (−z direction) or forwards (+z direction) with respect to the z direction of laser beam propagation. It is then advantageous to observe the antisymmetric signal ASYM(x, z, ε)=½(S(x, −z, ε)−S(x, z, ε)). The sign of this signal reverses if we reverse the direction of light propagation z: ASYM(x, +z, ε)=−ASYM(x, −z, ε). In addition, using a polarization modulator oscillating at frequency ω, the asymmetric angular distribution of ASYM electrons is modulated in time, in particular at natural frequencies ω₁=1/2 ω and ω₃=3/2 ω, at each position (x, z): ASYM(x, z, ω₁) and ASYM(x, z, ω₃).

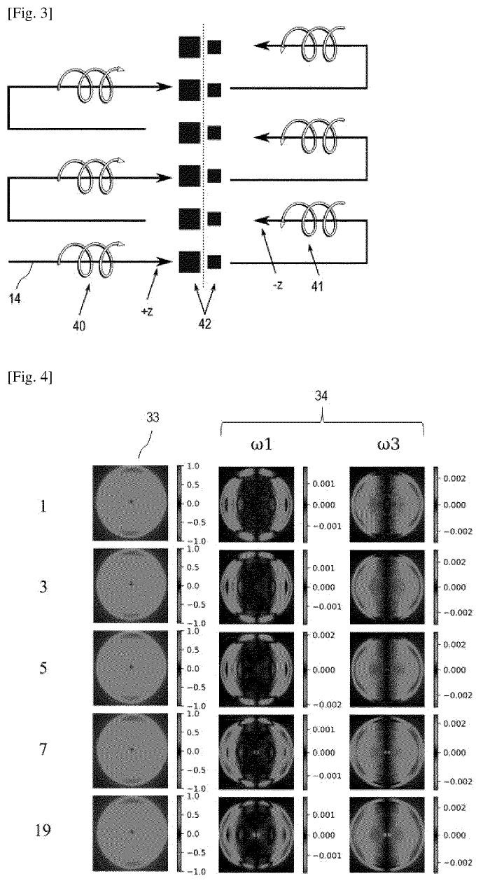

As the light beam 14 travels back and forth in the optical cavity 19, thus producing a sequence of pulses, the polarization state of the light beam 14 is reversed (the ellipticity changes sign) along with its direction of propagation. As the asymmetric signal is determined by this direction of rotation of light polarization, it reverses when the ellipticity changes sign: ASYM(x, z,ε)=−ASYM(x, z,−ε). Thus, by reversing both the direction of propagation and the sign of the polarization ellipticity each time the beam passes through the sample, the optical cavity 19 maintains a signal of the same sign since ASYM(x, z, ε)=ASYM(x, −z, −ε).

[FIG. 3] exemplifies the laser beam 14 passing through the optical cavity. The beam 14, which initially has a left-hand circular polarization (40) and propagates in the +z direction, changes polarization sign and propagation direction with each reflection. Polarization thus changes from circular left 40 to circular right 41, and the direction of propagation from +z to −z. The angular and/or spatial distribution of electrons is schematically indicated by squares 42. The total distribution generated by the entire sequence of laser pulses is virtually identical to a distribution generated by a single pulse. The distribution generated by the set of pulses has a better signal-to-noise ratio, as will be demonstrated below.

[FIG. 4] depicts average S(x, z) 33 and asymmetric ASYM(x, z, ω₁) and ASYM(x, z, ω₃) 34 photoelectron distributions for different numbers of focal points (1, 3, 5, 7 and 19 focal points), that is, light beam round trips in the cavity. The photoelectron distributions were imaged with an electrostatic lens in velocity vector imager mode of the photoelectrons produced. Imaging of photoelectron distributions is virtually independent of the number of focal points used.

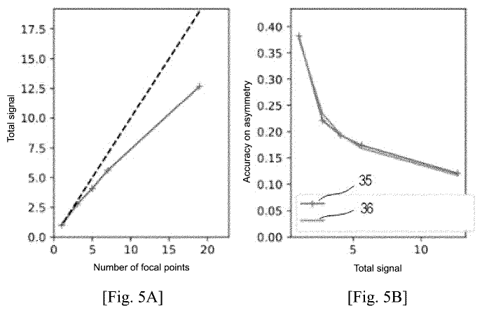

The system 1 according to the invention also comprises a determination device (not shown in [FIG. 1]), such as a computer. In particular, this device is arranged to determine the chirality of molecules from the spatial or angular distribution of electrons detected continuously as a function of time.

[FIG. 5] shows the results of measurements carried out with a system according to the invention.

[FIG. 5](a) shows the evolution of the total photoelectron signal as a function of the number of focal points. The signal increases almost proportionally to the number of times the beam passes through the optical cavity.

The curve 35 in [FIG. 5](b) shows the evolution of the dispersion of twenty-five 8 s measurements, as a function of the total signal measured. This dispersion is calculated as the standard deviation and represents the noise of the measurement. The curve 36 depicts a 1/√x adjustment of the curve 35.

It can be seen from FIG. 5(a) and 5(b) that as the number of beam passes through the cavity increases, the noise level decreases by a factor close to 1/√N, with N being the number of passes. However, 1/√x dependence is expected for any measurement whose acquisition time is increased by a factor x. This demonstrates that performing N passes is equivalent to increasing the measurement time by a factor of N. The principle of pulse recycling, implemented by the measurement system according to the present invention, therefore makes it possible to increase the signal level by a factor greater than 10, and to obtain an improvement in accuracy by a factor of about 3, equivalent to a measurement with an acquisition time 10 times longer, without using a more powerful and more expensive laser. Increasing the signal level also reduces measurement time.

Of course, the invention is not limited to the examples just described, and many adjustments can be made to these examples without going beyond the scope of the invention.

1-7. (canceled)

8. A system for characterizing chiral molecules, comprising:
an interaction zone arranged to receive a sample of chiral molecules;
a laser source arranged to emit pulsed laser radiation, the laser radiation being suitable for interacting with the molecules in the interaction zone;
a polarization modulator arranged to elliptically polarize the laser radiation;
an optical cavity configured to redirect the pulsed laser radiation into the interaction zone several times;
detection means arranged to measure a chiroptical signal produced by the interaction between the molecules and the laser radiation; and
determination means arranged and/or programmed to determine at least the chirality of the molecules from the detected chiroptical signal.

9. The system according to claim 8, wherein the interaction comprises ionization of the molecules, and the detection means comprise an electron detector arranged to detect a distribution of electrons produced by the ionization emitted in front of and behind the interaction zone with respect to the axis, z, of laser radiation propagation.

10. The system according to claim 8, wherein the optical cavity is formed by two spherical mirrors.

11. The system according to claim 8, wherein the polarization modulator is arranged to vary the polarization ellipticity of the laser radiation continuously as a function of time.

12. The system according to claim 11, wherein the polarization modulator comprises a quarter-wave plate arranged to be rotated about the axis, z, of laser radiation propagation.

13. The system according to claim 9, wherein the electron detector comprises at least one velocity vector imager.

14. The system according to claim 8, wherein the pulsed laser source is a femtosecond pulsed laser source.
